(19) United States
(12) Patent Application Publication
(10) Pub. No.: US 2005/0061155 A1
(43) Pub. Date: Mar. 24, 2005

(54) Method for air filtration monitoring in telecommunications equipment racks

(76) Inventor: John Philip Franey, Bridgewater, NJ (US)

Correspondence Address: Docket Administrator (Room 3J-219);Lucent Technologies Inc, 101 Crawfords Corner Road, Holmdel, NJ, 07733-3030, US

(21) Appl. No.: 10/669,943

(22) Filed: Sep. 24, 2003

(51) Int. Cl. B01D 46/00

(52) U.S. Cl. 96/421; 55/385.6

(57) ABSTRACT

A method and apparatus for automatically monitoring air filters in a telecommunication equipment rack is disclosed. One or more pressure switches are used to detect a pressure differential between air exiting the filter and a reference air pressure, such as the ambient air pressure in a telecommunications equipment facility. When a filter becomes contaminated, the pressure of the air exiting the filter will drop relative to the reference air pressure. When the pressure drop relative to the reference air pressure crosses a threshold, a signal indicative of the need to replace or clean the filter in the equipment rack is generated.

### FIELD OF THE INVENTION

The present invention relates generally to air filtration in computer equipment racks and, more particularly, to monitoring air filtration in a telecommunications equipment rack.

### BACKGROUND OF THE INVENTION

Computer equipment in general is sensitive to contamination from foreign particles, such as dirt and dust. Such contamination can potentially cause a failure in the operation of the computer because if allowed to collect on, for example, printed circuit boards, dust and dirt will tend to facilitate the collection of moisture on the circuit boards. Eventually, this moisture could be of such magnitude that a short circuit occurs on the printed circuit board, often requiring the replacement of the board. In addition to attracting moisture, the collection of dust and other debris in computer systems tends to inhibit airflow within the computer and, as a result, increases the operating temperature of the computer. Such an increase in temperature may cause premature failure of various components within the computer.

While such contamination is a concern in personal computers used in homes and businesses, it is especially significant in more expensive computer equipment, such as those computers used in telecommunications applications. Typical computers in telecommunications applications are used to, for example, establish voice and data transmissions, direct such transmissions to desired destinations, monitor telecommunication network loads, and maintain records of transmissions from individual users. Collectively, these computers may cost several orders of magnitude more to purchase and maintain than a typical personal computer. Therefore, such telecommunications computer equipment is typically placed in racks, which are well known in the computer art, to facilitate maintenance and to minimize the floor space necessary to house the equipment. Such racks also serve to isolate the computer equipment from the aforementioned foreign contaminants. Any contamination that would increase the maintenance costs of the computer equipment or reduce the serviceable life of that equipment is highly undesirable.

Traditional methods of preventing dust and other debris from contaminating telecommunications equipment in racks has primarily focused on preventing such dust and debris from entering the rooms/buildings within which the equipment is used. The air entering the room has traditionally been filtered very carefully so as to maintain the rooms in an exceptionally clean state. While filters have been used in equipment racks themselves, there was very little contamination collected by those filters and, accordingly, the equipment rack filters required replacement/cleaning very infrequently. Thus, manual periodic monitoring of the filters within the equipment racks was sufficient to ensure contamination remained at a minimum.

### SUMMARY OF THE INVENTION

While prior attempts to monitor and reduce the introduction of contaminants into telecommunication equipment racks are advantageous in many regards, they were limited in certain regards. For example, the present inventor has recognized that, while air entering telecommunication equipment facilities was carefully filtered in the past, more and more sensitive telecommunication equipment is being installed in areas of the world where such filtration is not maintained. For example, in certain areas of Asia as well as other parts of the world, such facilities are often left open to outside, unfiltered air. Thus, the filters in the equipment rack itself are now being relied upon as the primary filtration system to collect dust and other contaminants. As a result, these filters collect more contaminants in a shorter period of time and, accordingly, require frequent monitoring to ensure they are still effective. Replacement of the filters now must be accomplished on a more frequent basis. Since a typical telecommunication network has many such equipment facilities containing many racks of individual computer equipment components, manual monitoring of the filters in the racks can be time consuming and expensive.

Therefore, the present inventor has invented a method and apparatus for automatically monitoring air filters in a telecommunication equipment rack. Specifically, one or more pressure switches are used to detect a pressure differential between air exiting the filter and a reference air pressure, such as the ambient air pressure in the equipment facility. Since the equipment rack is typically an enclosure, when a filter becomes contaminated, the pressure of the air exiting the filter will drop relative to the reference air pressure. When the pressure drop relative to the reference air pressure reaches a certain magnitude, a signal indicative of the need to replace or clean the filter in the equipment rack is generated.

### BRIEF DESCRIPTION OF THE DRAWING

FIG. 1 shows a prior art telecommunications equipment rack;

FIG. 2 shows a telecommunication equipment rack in accordance with the principles of the present invention wherein a pressure switch is used to detect a pressure drop in the air exiting the filter; and

FIG. 3 shows an illustrative pressure differential switch useful in the equipment rack of FIG. 2.

### DETAILED DESCRIPTION

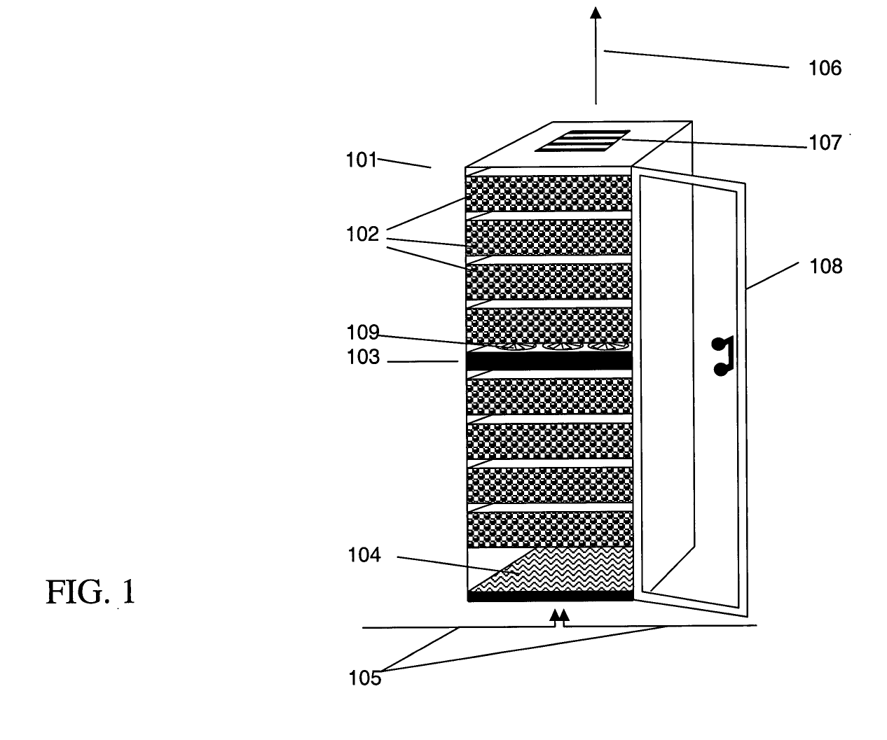

FIG. 1 shows an illustrative prior art telecommunication rack cabinet 101 useful at various facilities in a telecommunication network. Such cabinets are used, for example, to efficiently hold computer equipment components 102 that serve as network switches in establishing, routing and monitoring voice and data transmissions. One skilled in the art will recognize that many other types of equipment serving many different functions are typically contained in equipment racks such as cabinet 101. The illustrative cabinet 101 is an enclosure with door 108 that serves to isolate the components within the cabinet from the external environment. Fan unit 103 is illustratively a rack-mounted ventilation unit having one or more horizontally mounted fans that function to draw air into the cabinet in direction 105 through filter 104 upwards through the cabinet. Components 102 typically have vents in their respective tops and bottoms such that, when traveling upwards through the cabinet, air passes through the components and, thus, cools the electronics in that components. One skilled in the art will recognize that many such arrangements of fans 103 with respect to components 102 will be equally advantageous in cooling the components. Once the air passes through and reaches the top of the cabinet, the air exits the cabinet through vent 107 in direction 106. One skilled in the art will recognize, therefore, that it is desirable to prevent foreign contaminants from entering the cabinet, since that air will pass directly through components 102 and come into contact with potentially sensitive and expensive electronic elements within those components.

The present inventors have recognized that prior attempts to monitor and reduce the introduction of contaminants into telecommunication equipment cabinets, such as illustrative cabinet 101 may be insufficient to fully guard against contamination in all environments. For example, while air entering telecommunication equipment facilities housing cabinets such as cabinet 101 was carefully filtered in the past, more and more sensitive telecommunication equipment is being installed in areas of the world where such filtration is not maintained. For example, in certain areas of Asia as well as other parts of the world, such facilities are often left open to outside, unfiltered air. Thus, the filters, such as filter 104 in the equipment rack itself are now being relied upon as the primary filtration system to collect dust and other contaminants. As a result, these filters collect more contaminants in a shorter period of time and, accordingly, require more frequent monitoring to ensure they are still effective. Since past monitoring was typically entirely a manual process, the large number of cabinets and facilities holding such cabinets in a modern telecommunication network meant that frequent manual monitoring was a time consuming and expensive undertaking. Therefore, the present inventors have realized that it is preferable to have a more automated method of detecting when air filters within equipment cabinets require replacing or cleaning.

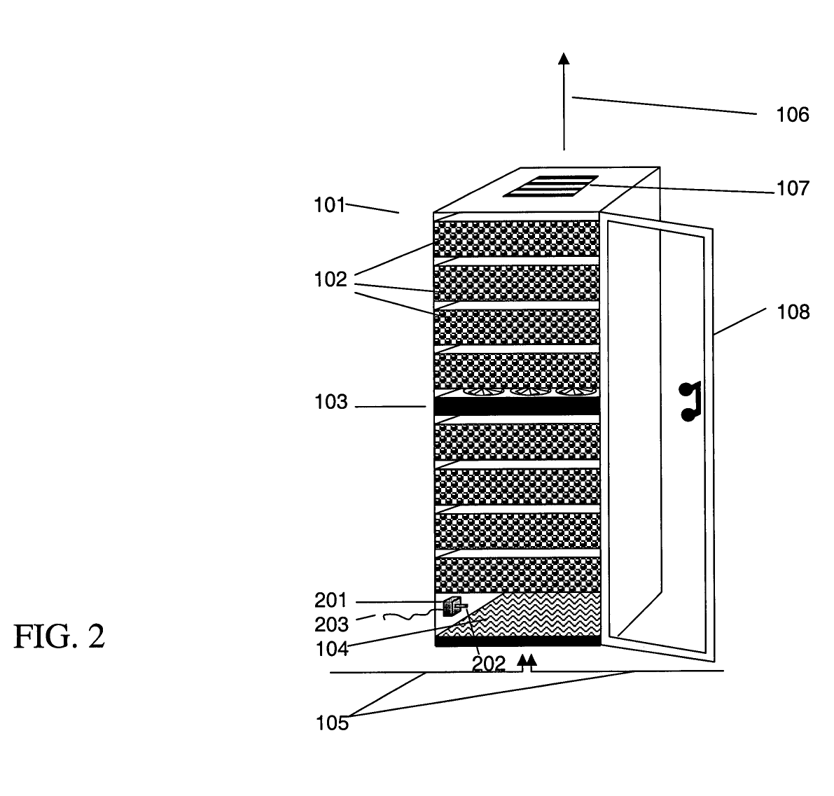

FIG. 2 shows one illustrative embodiment in accordance with the principles of the present invention whereby a pressure switch 201 is used to detect when a filter is becoming ineffective at filtering incoming air. Specifically, pressure switch 201 is placed illustratively within the equipment cabinet in a way such that it can directly detect the pressure of the air exiting the filter 104 as well as another reference source of air pressure, such as the ambient air surrounding the cabinet 101. The air pressure of the ambient air surrounding the cabinet is detected, for example, by a probe connected exposed to the air outside of the cabinet and connected to switch 201. One skilled in the art will be able to develop many alternative positions for the pressure switch such that both the pressure of air within the cabinet a reference source of air pressure can be measured. For example, the pressure switch may be mounted external to the cabinet 101 with a tube or tubes running to the respective sources of internal and reference air pressures.

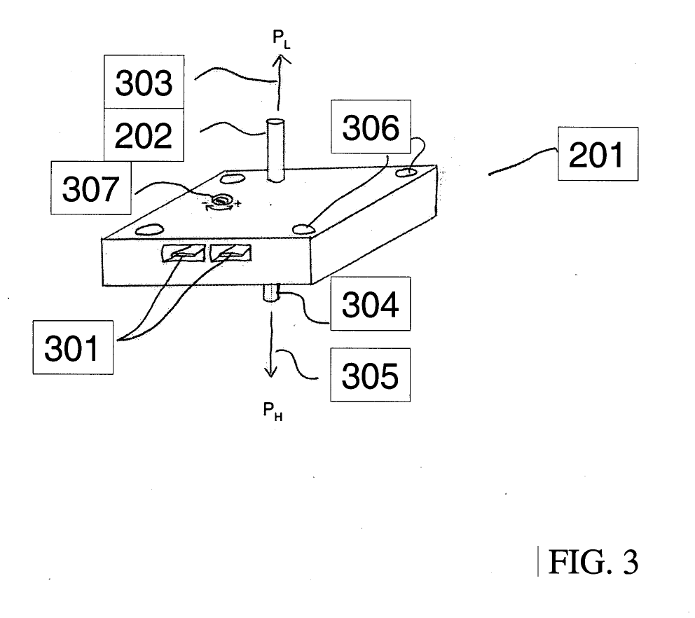

FIG. 3 shows an illustrative pressure switch suitable for use in such systems. The switch of FIG. 3 is, illustratively, a series MDA switch manufactured by Dwyer Electronics, Incorporated, of 102 Indiana Hwy. 212 Michigan City, Ind. 46361. The embodiments of the present invention are not intended to be limited to this particular switch, however. One skilled in the art will recognize that there are many similar pressure differential switches that are equally effective for use in the embodiments described herein. Referring to FIG. 3, switch 201 is illustratively mounted to an equipment cabinet, such as is shown, for example, in FIG. 2, using screws passing through holes 306. Probe 202 is either directly or indirectly exposed to air having pressure P_{L} and probe 304 is either directly or indirectly exposed to a reference air source having pressure P_{H}. Contacts 301 are connected to, for example, a computer used to monitor the two pressures P_{L} and P_{H}. Adjusting screw 307 sets the pressure differential threshold between pressures P_{L} and P_{H} at which, when crossed, will close an electrical switch within pressure switch 201. When the switch is closed, an electrical signal is, illustratively, sent to the computer. In response to this signal, the computer may generate a notification signal indicating that a set pressure differential threshold has been crossed.

Referring once again to FIG. 2, when the door 108 of cabinet 101 is closed, and fans 103 are operating, a probe 202 will be exposed to the air exiting air filter 104 having pressure P_{L}. Probe 304, which is not visible in FIG. 2, is exposed either directly or indirectly to the ambient air surrounding the cabinet having pressure P_{H}. Lead 203 is connected, illustratively to a computer either within or external to the cabinet 101. When filter 104 is substantially free of contaminants, the pressure P_{L} and the pressure P_{H} will be relatively close in magnitude to each other. Thus, the pressure differential P_{H}/P_{L} will be at or near a value of 1.0. However, as the filter 104 collects more contaminants from the surrounding air, the pressure P_{L} within the cabinet will drop. This is because, although the fans 103 are spinning at a constant speed, less air is being drawn through the contaminated filter. As the filter becomes more and more contaminated, the pressure P_{L} within the cabinet drops further until, at a particular point, illustratively that point where the area of the filter becomes 75% blocked, the differential threshold of switch 201 is crossed. At this point, an electrical switch within pressure switch 201 is closed and al electrical signal is sent, as described above, to the computer or other device connected via leads 203 to pressure switch 201. Upon receiving this electrical signal, the computer, illustratively, generates a signal indicative of a crossing of the pressure differential threshold and, thus, indicating that the filter 104 is in need of replacement or cleaning. Accordingly, manual inspection of filter 104 is not required until a signal is received indicating that such inspection may be warranted.

The foregoing merely illustrates the principles of the invention. It will thus be appreciated that those skilled in the art will be able to devise various arrangements which, although not explicitly described or shown herein, embody the principles of the invention and are within its spirit and scope. For example, one skilled in the art, in light of the descriptions of the various embodiments herein, will recognize that the principles of the present invention may be utilized in widely disparate fields and applications. All examples and conditional language recited herein are intended expressly to be only for pedagogical purposes to aid the reader in understanding the principles of the invention and are to be construed as being without limitation to such specifically recited examples and conditions. Moreover, all statements herein reciting aspects and embodiments of the invention, as well as specific examples thereof, are intended to encompass functional equivalents thereof.

1. An apparatus comprising:
an enclosure adapted to hold a plurality of telecommunications equipment components;
means for passing air into said enclosure in order to cool said plurality of telecommunications equipment components;
a filter for preventing airborne contaminants from entering said enclosure; and
means for detecting a first air pressure, said first air pressure indicative of a pressure of air exiting said filter and entering said enclosure;
means for detecting a second air pressure, said second air pressure indicative of a reference air pressure; and
means for generating a signal indicative of said first air pressure crossing a desired threshold relative to said second air pressure.

2. The apparatus of claim 1 wherein said means for detecting a first air pressure and said means for detecting a second air pressure comprise a single pressure differential switch device.

3. The apparatus of claim 1 wherein said second air pressure is the pressure of the ambient air surrounding said enclosure.

4. The apparatus of claim 1 wherein said means for detecting a first air pressure comprises a pressure differential switch device directly in contact with said air exiting said filter.

5. The apparatus of claim 1 wherein said means for detecting a first air pressure comprises a pressure differential switch device indirectly in contact with said air exiting said filter.

6. The apparatus of claim 1 wherein said means for detecting a second air pressure comprises a pressure differential switch device directly in contact with air associated with said reference air pressure.

7. The apparatus of claim 1 wherein said means for detecting a second air pressure comprises a pressure differential switch device indirectly in contact with air associated with said reference air pressure.

8. The apparatus of claim 2 wherein said pressure differential switch device is attached to a surface of said enclosure in a way such that said means for detecting a first air pressure is in direct contact with said air exiting said filter and said means for detecting a second air pressure is in direct contact with the ambient air surrounding said enclosure.

9. The apparatus of claim 8 wherein said pressure differential switch device is attached to an internal surface of said enclosure.

10. The apparatus of claim 8 wherein said pressure differential switch device is attached to an external surface of said enclosure.
